(19) United States
(12) Patent Application Publication
(10) Pub. No.: US 2010/0329604 A1
(43) Pub. Date: Dec. 30, 2010

(54) OPTICAL CONNECTOR

(75) Inventors: Seiji KOJIMA, Hitachi (JP); Kanako SUZUKI, Hitachi (JP); Yoshihiro NAKATANI, Hitachi (JP); Toshihiko ISHIKAWA, Hitachi (JP); Takao NISHIKAWA, Katsushika (JP); Kojiro ITO, Adachi (JP); Tetsuya SUEOKA, Ota (JP)

Correspondence Address: BRUNDIDGE & STANGER, P.C., 2318 MILL ROAD, SUITE 1020, ALEXANDRIA, VA, 22314, US

(73) Assignees: HITACHI CABLE, LTD., Tokyo (JP); Advanced Cable Systems Corporation, Tokyo (JP)

(21) Appl. No.: 12/825,945

(22) Filed: Jun. 29, 2010

(30) Foreign Application Priority Data
Jun. 30, 2009 (JP) 2009-155962

(51) Int. Cl. G02B 6/26

(52) U.S. Cl. 385/31

(57) ABSTRACT

An optical connector that requires no complicated fabrication operation such as highly accurate optical axis alignment and that permits an efficient pick up of part of the communication signal light being on-propagation along an optical transmission line, is provided. The optical connector 1 for connecting optical transmission lines each other is comprised of at least a connector main body 16 and a joining element 5 provided inside the connector main body 16 being interposed between the optical transmission lines and coupled to each end face of the optical transmission lines, wherein the joining element 5 is comprised of a core 3 and a cladding 4 provided on the periphery of the core 3 that are optically coupled to the optical transmission line, and a light pick-up means for picking up part of communication signal light being on-propagation along the optical transmission line, and wherein the connector main body 16 has, in a position that faces the light pick-up means, an optical output port 26 for outputting part of the communication signal light picked up by the light pick-up means to a light detector 2.

### TECHNICAL FIELD

The present invention relates to an optical connector that has a joining element inside the main body thereof to establish an optical connection between optical transmission lines enabling examination of communication status of the optical transmission line, wherein the joining element is comprised of a core and a cladding that are optically coupled to the optical transmission line.

### BACKGROUND ART

The communication signal light propagating along an optical transmission line is mostly invisible light that does not exist in the range of visible lights. Therefore, the visual examination is not applicable to operations in an optical communication facility such as a data center or an equipment office. Consequently, there have been problems such that it is not easy to determine whether a specific optical transmission line is in use or not and such that misunderstanding of a working optical transmission line being not-working causes accidental extraction of a working optical connector.

In view of improvement in maintainability or operational efficiency of an optical communication facility under these circumstances, various techniques have been studied for means for visual examination of whether communication signal light being on-propagation along an optical transmission line exists or not, with the optical fiber being connected.

For example, JP 2004-170488A discloses a method for detecting whether or not the communication signal light is on-transmission. In the method, a gap is provided between the end faces of optical-fiber-embedded ferrules that are to be butt-jointed in a split sleeve; an optical waveguide of light-permeable resin is interposed within the gap; the optical waveguide guides part of communication signal light toward upper side of the waveguide; and a phosphor receives the guided communication signal light to detect whether or not the communication signal light is on-transmission.

JP 2004-133071 A discloses another method. In the method, an optical waveguide substrate is arranged between the end faces of two optical-fiber-embedded ferrules; the optical waveguide substrate makes part of the communication signal light branched to be picked up at a communication signal light output part; and thereby it is examined whether the communication signal light exists or not.

JP 2003-218813A discloses further another method. In the method, a branching device is used to make part of the communication signal light branched to be picked up and a visible light transducer is installed on the end portion where branched light reaches.

The other documents related to the prior art concerning the optical connector for enabling examination of communication status of the optical transmission line are listed below.

JP 2002-214487A; and

JP 2004-177549A.

### SUMMARY OF THE INVENTION

Above-stated arts in Patent Literatures however still have problems. The art defined in JP 2004-170488A requires the waveguide to be installed in a very narrow gap. This feature requires a time consuming operation in fabrication of devices and demands a high precision in optical axis alignment. Further, the photo-detector being comprised of a phosphor causes visual examination to be hard because luminescence time length of such detector is extremely short; therefore, there has faced a difficulty in practicability of the art to an optical communication-related facility.

In the art described in JP 2004-170488A, an optical-fiber-embedded ferrule is fixed in a compressive manner. In this configuration, stress applied on the waveguide of resin interposed within the gap attributable to insertion and extraction of the ferrule (optical fiber) may cause flaking-off or abrasion on the waveguide. This situation is a problem in that the efficient guiding of the communication signal light to outside is not available and consequently in that the detecting of communication signal light with accuracy maintained over the long term is not feasible. Further, there is another problem in that the gap spacing control is difficult because the gap distance is adjusted relying on the loss measurement of the communication signal light using a power monitor.

The art defined in JP 2004-133071A needs connection of an optical waveguide substrate with a ferrule and with a communication signal light output part. In addition, this feature requires a time consuming operation in fabrication of devices and demands a high precision in optical axis alignment. Further, parts of the device such as the optical waveguide substrate are expensive. This situation has made it difficult to realize cost cutting for more spread practical use.

The art defined in JP 2003-218813A also has had a problem in that visual examination is hard because the luminescence time length of a visible light transducer is extremely short.

Moreover, there still has been problem. In a conventional optical connector, a light detection means such as a photo-detector or a photo-detection means for detecting part of communication signal light at a communication signal light output part is integrated in the optical connector. This configuration has been pushing up the cost of an optical connector and has been inviting size growth.

In view of these circumstances, the object of the present invention is to provide an optical connector that requires no complicated fabrication operation such as highly accurate optical axis alignment and that permits an efficient pick up of part of the communication signal light being on-propagation along an optical transmission line.

### MEANS FOR SOLVING THE PROBLEMS

The present invention has been made to attain the above-stated object.

The invention as defined in claim 1 is an optical connector for connecting optical transmission lines each other comprised of at least a connector main body and a joining element provided inside the connector main body being interposed between the optical transmission lines and coupled to each end face of the optical transmission lines, wherein the joining element is comprised of a core and a cladding provided on the periphery of the core that are optically coupled to the optical transmission lines, and a light pick-up means for picking up part of communication signal light being on-propagation along the optical transmission lines, and wherein the connector main body has, in a position that faces the light pick-up means, an optical output port for outputting part of the communication signal light picked up by the light pick-up means to a light detector.

The invention defined in claim 2 is such an optical connector as is described in claim 1, wherein the light pick-up means is comprised of a light detection groove formed, in a position that faces the optical output port, so that at least said core will be penetrated thereby.

The invention defined in claim 3 is such an optical connector as is described in claim 2, wherein the inside of the light detection groove is filled with a resin having a refractive index smaller than that of the core.

The invention defined in claim 4 is such an optical connector as is described in claim 2, wherein a scattering material that scatters part of the communication signal light to the optical output port is arranged inside the light detection groove.

The invention defined in claim 5 is such an optical connector as is described in claim 2, wherein an optical branching filter that makes part of the communication signal light branched to the optical output port is arranged inside the light detection groove.

The invention defined in claim 6 is such an optical connector as is described in claim 1, wherein the light pick-up means is comprised of an undulation portion formed on the surface of the core.

The invention defined in claim 7 is such an optical connector as is described in claim 1, wherein the light pick-up means is comprised of a distorted portion formed on part of the core so that such part will have a mode field diameter different from the other part of the core.

The invention defined in claim 8 is such an optical connector as is described in claim 1, wherein the light pick-up means has such a positional arrangement that the optical axis of the core on the end face of connection with a core of the optical transmission line is positioned being shifted from the optical axis of the core of the optical transmission line within an extent that the contact between the core and the core of the optical transmission line is maintained.

The invention defined in claim 9 is such an optical connector as is described in claim 1, wherein the light pick-up means has such a geometric arrangement that the diameter of the core on the end face of connection with a core of the optical transmission line is different from the diameter of the core of the optical transmission line.

The invention defined in claim 10 is such an optical connector as is described in claim 1, wherein the light pick-up means is comprised of a high refractive index component provided longitudinally in the cladding and having refraction index not smaller than that of the core, and a V-groove formed applying a V-cutting from the surface of the joining element, which surface faces to the light output port, to part of the high refractive index component in such a manner that the V-groove will slant with respect to the optical axis of the high refractive index component.

The invention defined in claim 11 is such an optical connector as is described in claim 1, wherein the light pick-up means is comprised of a flat part formed on the cladding longitudinally along the core so that part of the circumference of the cladding will be flat and an optical refraction part, having a circumference of the cladding will be flat and an optical refraction part, having a refractive index not smaller than that of the core, provided on part of the surface of the flat part.

The invention defined in claim 12 is such an optical connector as is described in claim 1, wherein the light pick-up means is comprised of an open part in an approximately-U-shaped arrangement of a plurality of cavities arrayed surrounding the core.

The invention defined in claim 13 is such an optical connector as is described in claim 12, wherein the open part is curved at the portion thereof that faces the optical output port toward the optical output port.

The invention defined in claim 14 is such an optical connector as is described in claim 1, wherein a cover for closing the optical output port is provided on the connector main body in an openable-and-closable manner.

The invention defined in claim 15 is such an optical connector as is described in claim 1, wherein the light detector is attached on the connector main body in a detachable manner.

The present invention is able to provide an optical connector that requires no complicated fabrication operation such as highly accurate optical axis alignment and that permits an efficient pick up of part of the communication signal light being on-propagation along an optical transmission line.

### BRIEF DESCRIPTION OF DRAWINGS

FIG. 1 is a schematic sectional view of an optical connector in an embodiment of the present invention.

FIG. 2 illustrates an example of the light pick-up means in an embodiment of the present invention.

FIG. 3 is a schematic sectional view of an optical connector in an embodiment of the present invention.

FIG. 4 illustrates an example of the light pick-up means in an embodiment of the present invention.

FIG. 5 illustrates an example of the light pick-up means in an embodiment of the present invention.

FIG. 6A is a perspective view of the optical connector illustrated in FIG. 3 and FIG. 6B is a perspective-cross sectional view of the optical connector illustrated in FIG. 3.

FIG. 7A is a perspective view of an example of the light detector to be attached on the optical connector illustrated in FIG. 3 and FIG. 7B is a sectional-perspective view of the light detector illustrated in FIG. 7A.

FIGS. 8A-8C illustrate an example of the light pick-up means in an embodiment of the present invention.

FIG. 9 illustrates an example of the light pick-up means in an embodiment of the present invention.

FIGS. 10A and 10B illustrate an example of the light pick-up means in an embodiment of the present invention.

FIGS. 11A and 11B illustrate an example of the light pick-up means in an embodiment of the present invention.

FIGS. 12A-12C illustrate an example of the light pick-up means in an embodiment of the present invention.

FIGS. 13A and 13B illustrate an example of the light pick-up means in an embodiment of the present invention.

FIGS. 14A-14C illustrate an example of the light pick-up means in an embodiment of the present invention.

### DETAILED DESCRIPTION OF THE PREFERRED EMBODIMENTS

The following will explain preferred modes of implementation of the present invention referring to attached drawings.

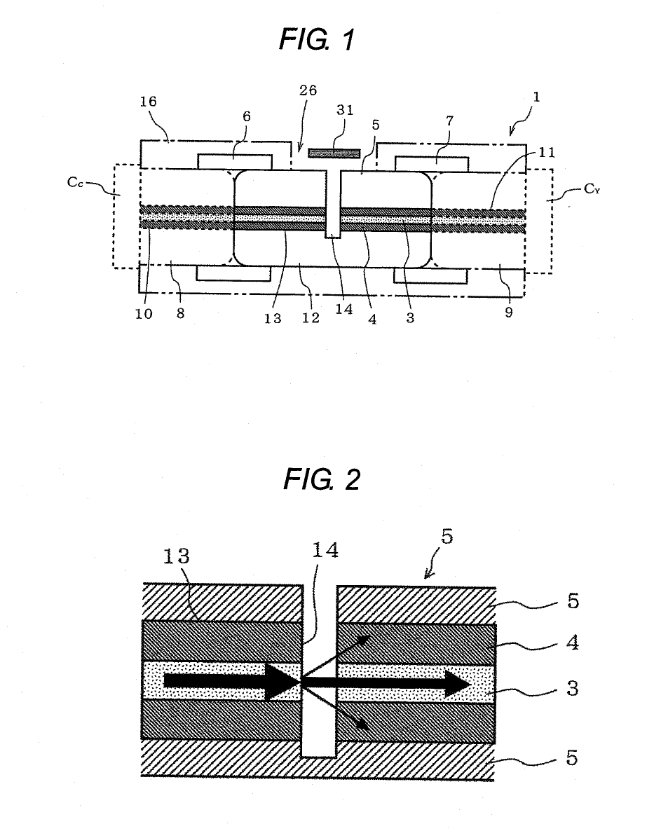

FIG. 1 is a schematic sectional view of an optical connector in the first embodiment of the present invention.

As FIG. 1 illustrates, an optical connector 1 is a device that optically connects optical transmission lines each other, picks up part of the communication signal light, and outputs the picked up communication signal light to a light-reception component 31 of a light detector 2 (FIG. 1 illustrates part of the light detector 2). The light detector 2, details of which will be described later, is a device for detecting the picked up communication signal light. As the light detector 2 has a structure separate from the optical connector 1, the light detector 2 is attached on the optical connector 1 in a detachable manner. With this configuration, the optical connector 1 can be small-sized and further one light detector 2 is applicable commonly to a plurality of the optical connectors 1 greatly attributing to cost cutting.

The optical connector 1 has a joining element 5 inside a connector main body 16 to optically connect optical transmission lines each other that are optical fibers 10 and 11 embedded respectively in ferrules 8 and 9. The joining element 5 is comprised of a core 3 and a cladding 4 that are to be optically coupled to cores of optical fibers 10 and 11 for establishing the optical connection. This means that the optical connector 1 is comprised of at least the connector main body 16 and the joining element 5 arranged inside the connector main body 16 and interposed between the optical transmission lines, wherein the joining element 5 joins to each end face of the optical transmission lines. From the viewpoint of controlling the production of transmission loss, the external diameters of the core 3 and the cladding 4 should preferably be same as those of the core and the cladding of the optical fiber respectively.

The outer peripheries of the both ends of the joining element 5 are inserted respectively into sleeves 6 and 7 accommodated in the connector main body 16 to be fixed severally in the sleeves. On the both end surfaces of the joining element 5, a cylindrical ferrule 8 provided on the SC connector C_{C} on the equipment side and a cylindrical ferrule 9 provided on the SC connector C_{Y} on the user side are placed for a butt-connection when the optical connector 1 is to be used. That is, the joining element 5 is interposed between the optical transmission lines accommodated in the connector main body 16 and joins to each end face of the optical transmission lines. The ferrule 8 embeds the optical fiber 10 therein, which is the optical transmission line on the equipment side; the ferrule 9 embeds the optical fiber 11 therein, which is the optical transmission line on the user side. The sleeve 6 is for aligning the optical axis of the ferrule 8 with optical axis of the joining element 5; the sleeve 7 is for aligning the optical axis of the ferrule 9 with optical axis of the joining element 5. This means that the core 3 and the cladding 4 are in alignment with the optical fibers 10 and 11 that are the optical transmission lines.

The joining element 5 is comprised of a ferrule 12, which is further comprised of the core 3 and the cladding 4 provided over the core 3. The core 3 butt-connects to each end of the optical fibers 10 and 11 (ends on the connection side of the optical fiber); the cladding 4 has a refractive index lower than that of the core 3. The core 3 is manufactured using the same material as each of the cores of the optical fibers 10 and 11; the cladding 4 is manufactured using the same material as each of the cladding of the optical fibers 10 and 11. An optical waveguide or an optical fiber may be used in the core 3 and cladding 4. In this embodiment, the joining element 5 uses the ferrule 12 that has an optical fiber 13 embedded therein that is the same optical fiber as the optical fibers 10 and 11.

It is preferable to use a single-mode optical fiber of silica glass or a graded-index (GI) type multi-mode optical fiber as the optical fibers 10, 11, and 13. The core diameters of the optical fiber 13 and the optical fibers 10 and 11 should preferably be same (10 μm for example).

It is preferable to use such a material like zirconia for example as transmits lights in a wavelength range for communication signal lights and scatters the communication signal light on receipt thereof.

Both end faces of the joining element 5, to which the optical transmission lines are connected, are polished into physical contact (PC) end faces since those faces are connected with the end faces of the ferrules 8 and 9 (the end faces of the optical fiber on the connection side), which are to be inserted into the optical connector 1, in the PC manner. The outer diameter of the joining element 5 is same as the outer diameter of the ferrules 8 and 9.

In the above-stated configuration, the ferrule 8 is housed in the SC connector C_{C} on the equipment side and the ferrule 9 is contained in the SC connector C_{Y} on the user side. These ferrules 8 and 9 are made of ceramic or metal, the end faces of which (the end faces to which the optical fiber is connected) are polished into the PC end face.

The joining element 5 has a light pick-up means for picking up part of the communication signal light that is on-propagation along the core 3. The light pick-up means is a means for guiding part of the communication signal light toward the light detector 2 for example.

In the first embodiment, the light pick-up means is comprised of a light detection groove 14.

As illustrated in FIG. 2, the light detection groove 14 is a groove formed from such part of the surface of the joining element 5 as faces the light reception component of a light detector to a depth to reach at least the core 3 (the core of the optical fiber 13) to pick up part of the communication signal light (the thick arrow in FIG. 2) as a leakage light (the thin arrow in FIG. 2).

The light detection groove 14 is formed perpendicular to the optical axis of the core 3 of the joining element 5 and is shaped approximately rectangular in a vertical sectional view (like a recess or an alcove). The light detection groove 14 is carved by grooving by dice cutting with a blade or etching for example.

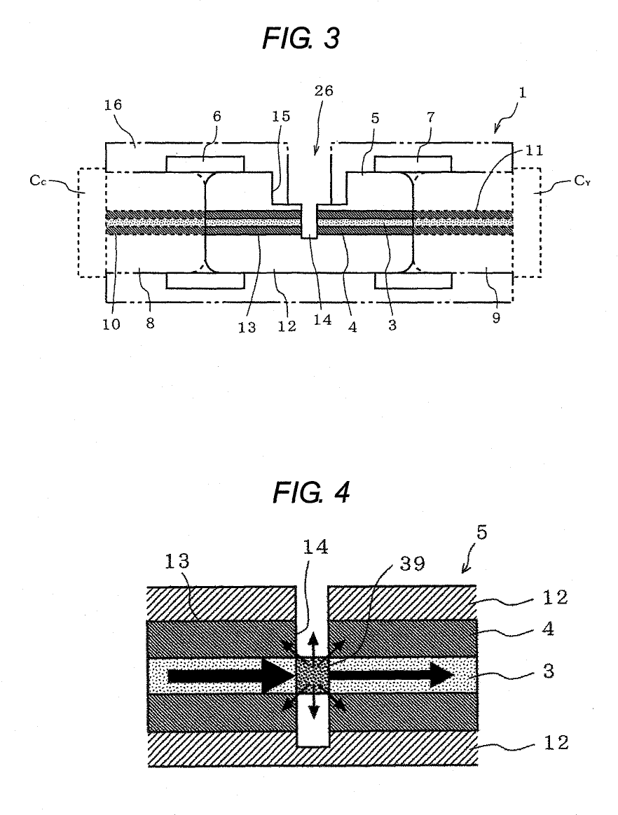

As illustrated in FIG. 3 in the first embodiment, an accommodation groove 15 for accommodating a light reception component of the light detector 2 facing the light detection groove 14 is formed on the ferrule 12 of the joining element 5, and the light detection groove 14 is formed on the bottom of the accommodation groove 15. This configuration is for enhancing the detection sensitivity by positioning the light reception component of the light detector 2 close to the optical fiber 13 (positioning the light reception component of the light detector 2 close to the core 3 that leaks the light).

The accommodation groove 15 is a groove, having a concave-shape for example, provided on such a portion of the side face among the opposing side faces of the joining element 5 as is either of two side faces located in the direction across the diameter of the joining element 5 (the vertical direction in the sectional view of FIG. 3) and faces the light detection groove 14.

A properly designed groove width of the light detection groove 14 enables controlling the amount of the leakage light to the desired value with a good repeatability and high reliability. This means that such design permits efficient pick-up of part of the communication signal light that is on-propagation along the optical transmission line.

Further, the invented optical connector has less number of constituent parts compared to conventional optical connectors and the joining element 5 thereof is obtainable by simplified manufacturing method such as dice cutting. Therefore, the cost is repressed.

As illustrated in FIG. 4, it may be practicable to fill the light detection groove 14 partly or fully with a scattering medium 39 like zirconia to make the communication signal light scattered thereby for picking up part thereof. The scattering medium 39 should preferably fill the light detection groove 14 so as to cover at least the end face of the core 3 of the optical fiber 13 and to occupy the same width as the width of the light detection groove 14. It may also be practicable to use a resin having a refractive index smaller than that of the core 3 for filling the light detection groove 14. Filling the light detection groove 14 with such a resin as has a refractive index smaller than that of the core 3 enlarges the scattering spread of the leakage light in the light detection groove 14 (an angle of scatter with respect to the optical axis of the core 3) permitting scattering the leakage light in a location close to the center of the light detection groove 14, that is a position close to the light reception component 31, and enables the detection sensitivity to be enhanced.

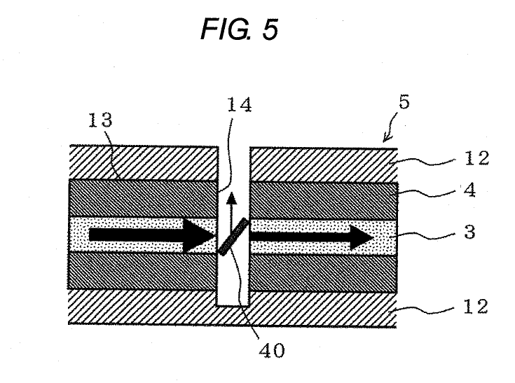

Further, as FIG. 5 illustrates, it may be practicable to install an optical branching filter 40 in the light detection groove 14, intersecting the optical axis of the core 3 of the joining element 5 at a slant angle of 45 degrees for example, for branching part of the communication signal light by the optical branching filter 40 into the direction perpendicular to the optical axis of the core 3 for being picked up. In this arrangement, the optical branching filter 40 should preferably have such a diameter that the dimension along the direction perpendicular to the optical axis of the core 3 is larger than the diameter of the core 3 when mounted on the slant with respect to the optical axis of the core 3. As stated above, where the optical branching filter 40 is installed in the light detection groove 14, it is promising that the detection sensitivity of the leakage light will be enhanced because of the directivity of the leakage light becomes agreeable.

The space around the scattering medium 39 or the branching filter 40 may be filled with an index matching agent. Thereby, ingress of water or moisture into the light detection groove 14 is prevented with increased reliability.

It should be understood that the shape of the light detection groove 14 is not limited to such a shape as is approximately rectangular in a vertical sectional view, but such a shape as is approximately V-shape in a vertical sectional view may also be practicable.

Further, such an arrangement that two ferrules 12 having optical fibers 13 embedded therein are positioned with a predetermined spacing helped by a sleeve to form a groove for light detection may also be feasible. In this configuration, the light reception component 31 of the light detector 2 should preferably be positioned at the location that is opposite to the light detection groove above the sleeve.

The connector main body 16 that accommodates the joining element 5 having such light pick-up means has a light output port 26 that, being provided at the location that faces the light pick-up means, outputs part of the communication signal light picked up by the light pick-up means to the light detector 2. The light output port 26 outputs the output from the light detection groove 14 of the joining element 5 to the light detector 2 and is for enabling the light detector 2 to be detachably mounted on the connector main body 16 permitting insertion and extraction thereof.

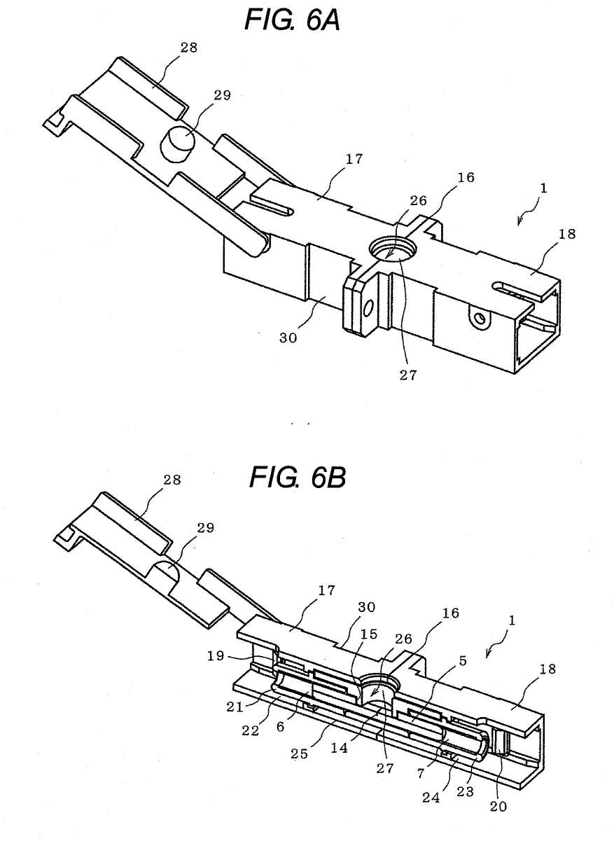

More detailed explanation of the connector main body 16 of the optical connector 1 follows referring to FIGS. 6A and 6B.

The connector main body 16, which accommodates the joining element 5, has a square tube shape. One end thereof (the left side part in FIGS. 6A-6B) is an optical connector adapter 17 on the equipment side and the other end thereof (the right side part in FIGS. 6A-6B) is an optical connector adapter 18 on the user side. In the optical connector adapter 17 on the equipment side, an SC attachment 19 is provided for inserting and fixing in advance the SC connector C_{C} (not illustrated) on the equipment side. Likewise, in the optical connector adapter 18 on the user side, an SC attachment 20 is provided for fixing the SC connector C_{Y} (not illustrated) on the user side designed being capable of inserting and extracting.

In the inner area of the optical connector adapter 17 seeing from the SC attachment 19 (toward the optical connector adapter 18), a sleeve holder accommodation room 22 is formed to house a sleeve holder 21 on the equipment side. The sleeve holder 21 is housed in advance in the sleeve holder accommodation room 22. Likewise, in the inner area of the optical connector adapter 18 seeing from the SC attachment 20 (toward the optical connector adapter 17), a sleeve holder accommodation room 24 is formed to house a sleeve holder 23 on the equipment side. The sleeve holder 23 is housed in advance in the sleeve holder accommodation room 24.

In the middle of the connector main body 16, a main body accommodation room 25 is formed. The main body accommodation room 25 houses two sleeves 6 and 7 and the joining element 5 that is retained between the sleeves 6 and 7. The sleeves 6 and 7 and the joining element 5 are housed in advance in the main body accommodation room 25. Above the main body accommodation room 25 of the connector main body 16, the light output port 26 is formed for outputting part of the communication signal light picked up by the light pick-up means.

The light output port 26, which sends out the output from the light pick-up means to the light detector 2, has a detection hole 27 that permits the light detector 2 to be detachably mounted on the connector main body with insertion and extraction thereof enabled. To prevent invasion of foreign matters into the detection hole 27, a cover 28 is provided on the connector main body 16. The cover, which is installed in an openable-and-closable manner, prevents foreign matters from encroaching into the detection hole 27 when the light detector 2 is not attached on the connector main body 16. On the cover 28, a cylindrical shape dust prevention plug 29 that fits with the detection hole 27 is provided.

On the side face of the connector main body 16, a guide groove 30 is formed for guiding the light reception component of the light detector 2 to the detection hole 27 to position the light detector 2 in place in the attaching thereof.

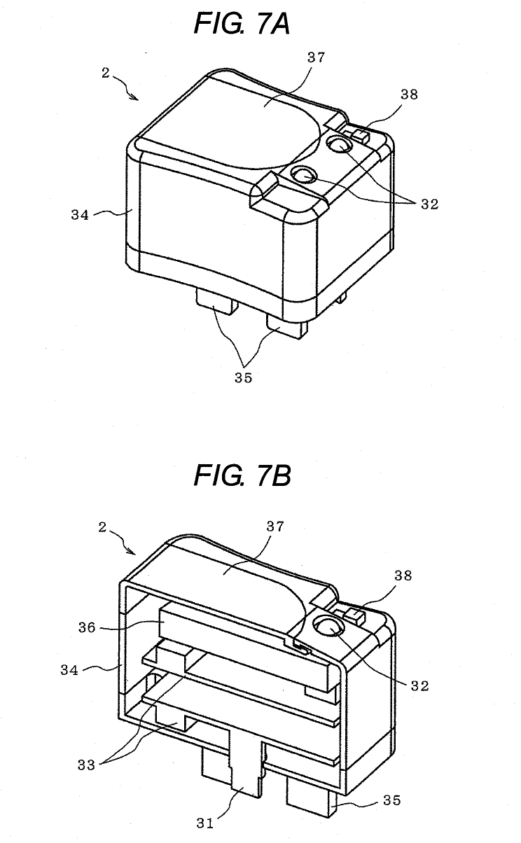

As illustrated in FIGS. 7A and 7B, the light detector 2 to be attached on the connector main body 16 has a housing 34 that accommodates a circuit board 33 having a light detection circuitry configured by the light reception component 31 and a light output component 32 mounted thereon.

The light reception component 31 is provided protruding from the bottom of the housing 34 so as to face the light pick-up means when the light detector 2 is attached on the optical connector 1. The light reception component 31 is for receiving part of the communication signal light (leakage light) leaked from the core 3 by the light pick-up means; the component is comprised of a photo diode (PD) for example.

The light outputting component 32 is provided on the top face of the housing 34. The light output component 32 is a communication status indication lamp that emits visible light transduced from the leakage light received by the light reception component 31; the component is comprised of a light emitting diode (LED) for example.

On the bottom face of the housing 34, a plurality of legs 35 (four legs in the example illustrated in FIGS. 7A and 7B) that are to be inserted into the guide grooves 30 are formed. Inside the housing 34, a battery 36 is accommodated for power feeding to the light reception component 31 and light output component 32.

On the top face of the housing 34, a lid portion 37 is formed modifying part of the top face of the housing 34 so that such part will be a detachable lid to permit replacement of the battery 36. Also on the top face of the housing 34, a power switch 38 is provided for switching the power feeding from the battery 36.

FIGS. 7A and 7B illustrate such a case that the light output component 32 is provided in two numbers; but providing one component is feasible. It is also feasible to use one of two light output components 32 as a power source indicator lamp to indicate ON/OFF status of the power feeding.

The following explains the operation of this embodiment.

The optical connector 1 optically connects the optical fibers 10 with 11 using the joining element 5 having core 3 and cladding 4 that are to be optically coupled to the optical fibers 10 and 11 on the equipment side and the user side respectively. When the optical connector 1 is in operation, the cover 28 provided on the connector main body 16 is always shut by plugging the dust prevention plug 29 into the detection hole 27 as the light output port 26 for protection preventing foreign matters from invading the light pick-up means through the light output port 26.

For detection of the communication signal light on the optical connector 1, the leg 35 of the light detector 2 is inserted along the guide groove 30 on the optical connector 1 opening the cover 28 to expose the light output port 26. With these operational steps, the light reception component 31 protruded from the bottom face of the housing 34 is accommodated in position in the detector hole 27, that is, the light output port 26. Turning the power switch 38 to ON under this condition enables the communication signal light detection.

As stated above, the optical connector 1 permits such a manner of use that the light detector 2 is attached thereon only when demand for examination of existence of the communication signal light arises, and is retained usually as a separate off-line device. Therefore, one light detector 2 is enough for serving examination of existence of the communication signal light over plural optical connectors 1. Thereby, costs related to light detectors can be significantly reduced because, in many cases, optical communication facilities such as a data center or a equipment office use a huge number of optical connectors.

Further, the optical connector 1 can be small-sized by dimensional extent or voluminal amount that the light detector 2 would have occupied in an integrated configuration, because the optical connector 1 and the light detector 2 are separate component each other. Furthermore, the optical connector 1 will be realized at a reduced cost since less number of parts are involved therein.

Moreover, the optical connector 1 requires no complicated fabrication operation such as highly accurate optical axis alignment with lessened time for fabrication, because the picking up of part of the communication signal light is performed using the joining element 5 that has the light detection groove 14.

In addition, the optical connector 1 establishes a butt-joint using the joining element 5 between end faces of the optical fibers 10 and 11 on the equipment side and the user side, which have been inserted at the time of use of the optical connector 1. Therefore, insertion-and-extraction of the optical connector 1 little stresses the joining element 5. Even if the joining element 5 is stressed resulting in an abrasion on its end face, no adverse effect occurs on the light detection groove 14 at all. This means that the picking up of part of the communication signal light can be performed with good efficiency for long time.

Still more, that the optical connector 1 uses the ferrule 12 made of such a material as transmits and scatters the leakage light more improves the leakage light detection sensitivity of the light reception component 31 thereof, because the leakage light is scattered at the point where the leakage light reaches the ferrule 12 travelling from the optical fiber 13.

The embodiment employs the joining element 5 having the accommodation groove 15 formed on the ferrule 12 and is configured so that the light reception component 31 of the light detector 2 will be accommodated in the accommodation groove 15. However, it may be feasible to use a joining element having no accommodation groove 15 with such a configuration that the light reception component 31 of the light detector 2 is arranged above the ferrule 12.

Next, further embodiments from second to fifth embodiments will be explained hereunder. Optical connectors of these second to fifth embodiments have different light pick-up means in their configuration from that in the first embodiment.

An optical connector by the second embodiment is characterized in that part of the core 3 of the joining element 5 is partly given a longitudinal shape modification. More particularly, micro-bend (undulation) partly formed on the joining element 5 functions as the light pick-up means.

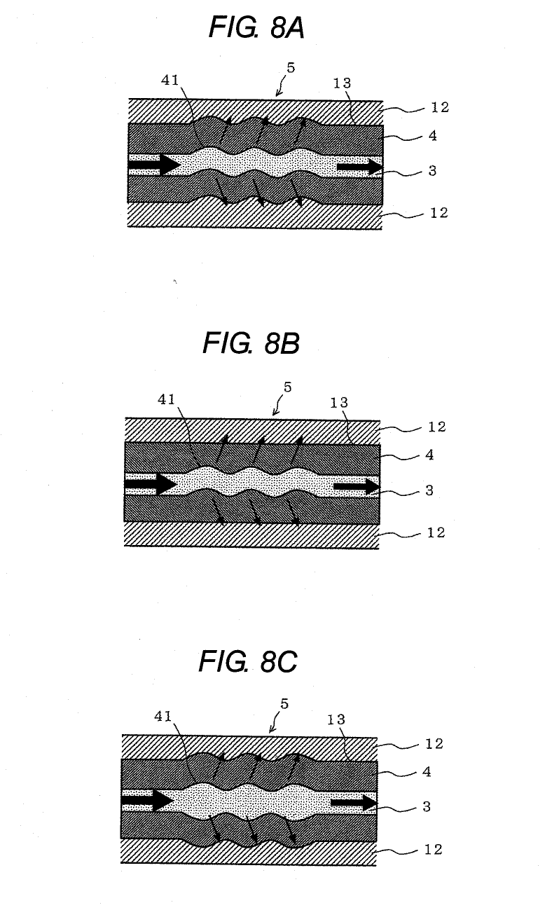

As illustrated in FIGS. 8A to 8C, a micro-bend 41 is an undulating portion formed on such a portion of the core 3 of the joining element 5 as faces the light reception component of the light detector.

Forming the micro-bend 41 on purpose on the core products a transmission loss of the communication signal light, in other words, generates leakage light. Detecting this leakage light with the light reception component 31 of the light detector 2 enables examination of existence of communication signal light.

The micro-bend 41 is formed by providing a hole having periodical bend in the ferrule 12 in which the optical fiber 13 is to be embedded and then inserting the optical fiber 13 into the periodically-bent hole so that the core 3 will form undulation (FIG. 8A); or instead, by irradiating CO₂ laser beam periodically in the drawing process of the preform for the optical fiber 13 to be embedded in the ferrule 12 so that part of the core 3 will undulate (FIG. 8B). Alternatively, irradiating laser beam periodically on the ferrule 12 having the optical fiber 13 embedded therein to obtain undulating surfaces on the core 3 and the cladding 4 of the optical fiber 13 is feasible for the same purpose, as shown in FIG. 8C.

The optical connector by the second embodiment provides the same effect as the optical connector 1 provides. That is, the optical connector requires no complicated fabrication operation such as highly accurate optical axis alignment, permits an efficient pick up of part of the communication signal light being on-propagation along an optical transmission line, and enables small-sizing by separating the light detection means with cost reduced.

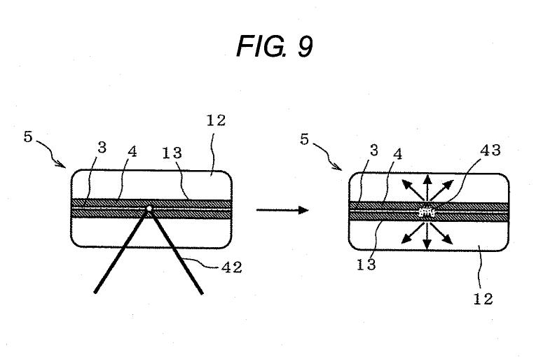

Other than the micro-bend 41, a distorted portion provided as illustrated in FIG. 9 may be used as the light pick-up means.

A distorted portion 43 is such part of the core 3 as has a distortion formed partially thereon. This partial distortion is produced by irradiating a CO₂ laser beam 42 from outside to such part of the core 3 of the joining element 5 as faces the light reception component of the light detector to thermally diffuse dopant such as germanium (Ge) added to the core 3, and thereby enlarging the mode field diameter (MFD) of the heat-applied portion of the core 3 to cause distortion partly therein.

In the distorted portion 43, the MFD thereof is larger than that of the core 3 of the other portion. The difference between these MFDs produces leakage light at the MFD-difference point. When the leakage light enters the ferrule 12, the ferrule 12 scatters such incident light. Part of thus scattered light is received by the light reception component 31 of the light detector 2. This reception indicates that the communication signal light exists.

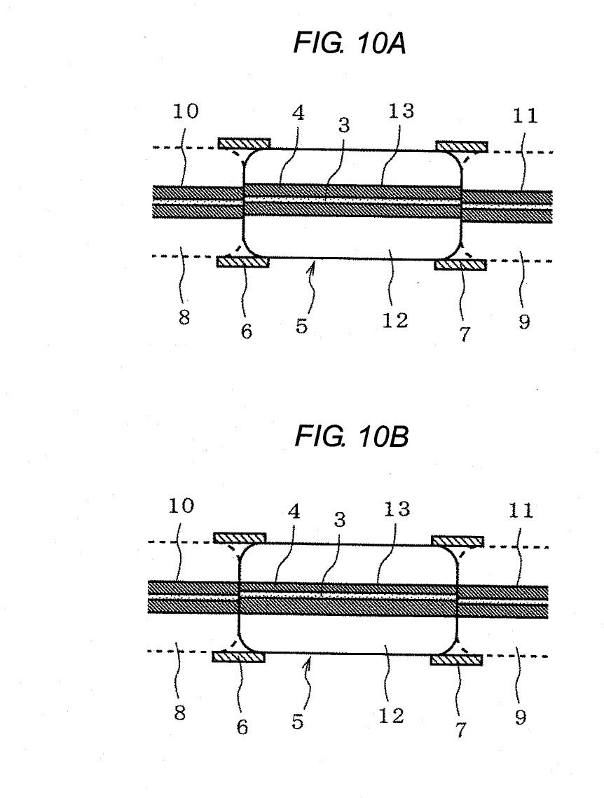

An optical connector by the third embodiment is characterized in that the light is picked up at the end face of the joining element 5 that is an optical connection interface with the optical transmission line. More specifically, such optical connection is constituted in a manner, wherein the insertion hole of the ferrule 12, into which the optical fiber 13 is to be inserted, is positioned at a location shifted from the inline position of the holes of the ferrules 8 and 9 to be connected, as illustrated in FIG. 10A, and thereby the optical connection is established at the connecting point (connecting end faces) of the ferrule 12 with the optical axis of the core (the core 3) of the optical fiber 13 shifted from the optical axes of the optical fibers 10 and 11 of the transmission line. In FIG. 10A, the shift of the hole of the ferrule 12 is illustrated upwards in the figure; however, shifting downwards in the figure is also feasible.

Instead, it is practicable to cause the axis-shift as illustrated in FIG. 10B by passing the optical fiber 13 having its core off-centered into the ferrule 12. In this arrangement, providing the hole of the ferrule 12 in-line with the holes of the ferrules 8 and 9 is acceptable.

Where the optical axis of the core of the optical fiber 13 is positioned with an axis-shift with respect to the optical axis of the core of the optical fibers 10 and 11 of the transmission line, the light leaked from the axis-shift point incident on the ferrule 12 is scattered as in the case of the arrangement with the distorted portion 43. Receiving part of the light thus scattered with the light reception component 31 of the light detector 2 enables examination of existence of the communication signal light.

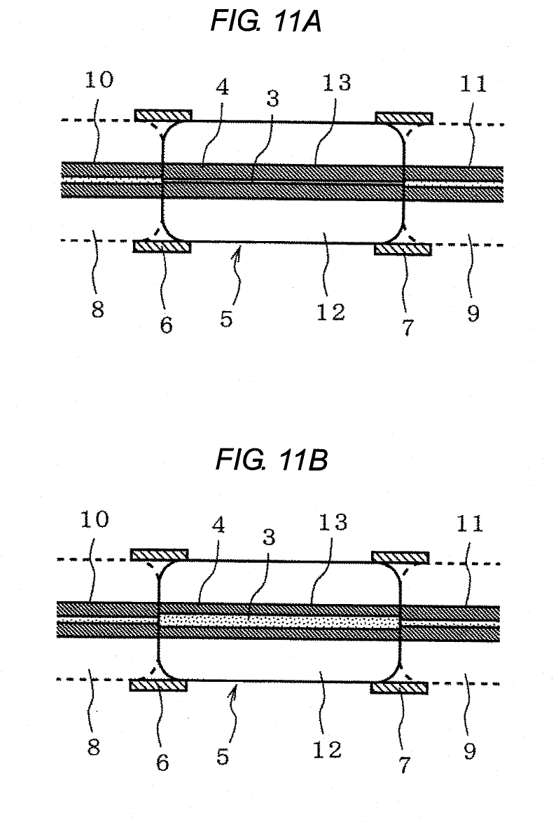

Further, it is also feasible to generate a leakage light from the connection points between the optical fiber 13 and the optical fibers 10 and 11 of the transmission line with an arrangement as illustrated in FIGS. 11A and 11B, wherein the arrangement is that the diameter of the core of the optical fiber 13 to be embedded in the ferrule 12 is made smaller than the diameter of the cores of the optical fibers 10 and 11 (FIG. 11A), or instead that the diameter of the core of the optical fiber 13 to be embedded in the ferrule 12 is made larger than the diameter of the cores of the optical fibers 10 and 11 (FIG. 11B).

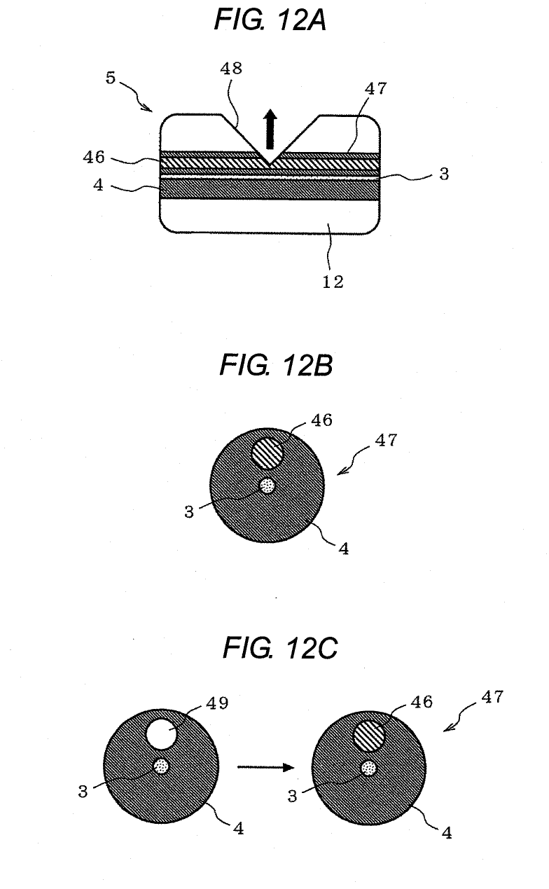

An optical connector by the fourth embodiment is characterized in that the joining element 5 is provided with a light pick-up portion having a refractive index not smaller than the refractive index of the core 3 of the joining element 5. More specifically, this light pick-up portion is a V-groove as illustrated in FIG. 12A and is provided by a method described below. A light detection optical fiber 47 is formed using the optical fiber 13, wherein a high refractive index component 46 is provided longitudinally in the cladding (cladding 4) of the optical fiber 13 in the position close to the core (core 3) thereof, wherein the refractive index of the high refraction index component 46 is not smaller than the refractive index of the core of the optical fiber 13. The light detection optical fiber 47 thus formed is embedded, or integrated, in the ferrule 12. The ferrule 12 then undergoes a V-shape cutting with a slant, 45 degrees for example, with respect to the optical axis of the high refractive index component 46 over an extent from the periphery of the ferrule 12 to part of the high refractive index component 46 in the light detection optical fiber 47. This V-shape cutting creates a V-groove 48 on the ferrule 12 with the light pick-up efficiency enhanced.

The light detection optical fiber 47 may be obtainable by methods described below. One method is, as illustrated in FIG. 12B, forming a preform having a construction in which the high refractive index component 46 is provided in the cladding in the position close to the core, and then drawing the preform. The other method is, as illustrated in FIG. 12C: forming a preform having a construction in which a hollow 49 is provided in the cladding in the position close to the core and then drawing the preform; filling the hollow 49 with a high refractive index resin of UV-curable type or thermo-setting type; and hardening the resin filled therein, with the high refractive index component 46 provided in the cladding.

In this light pick-up means comprised of the high refractive index component 46 and the V-groove 48, light is picked up at the V-groove 48 formed by cutting the high refractive index component 46 to which part of the communication signal light propagating in the core 3 of the joining element 5 is made coupled. This configuration does not give any work on the portion (core 3) that conveys communication; therefore, the configuration does not affect on the transmission properties.

Further, because the V-groove 48 is formed by a V-shape cutting with a slant of 45 degrees with respect to the optical axis of the high refractive index component 46, the light perpendicular to the optical axis of the core 3, i.e., directional toward the light detector, is picked up with the detection sensitivity enhanced.

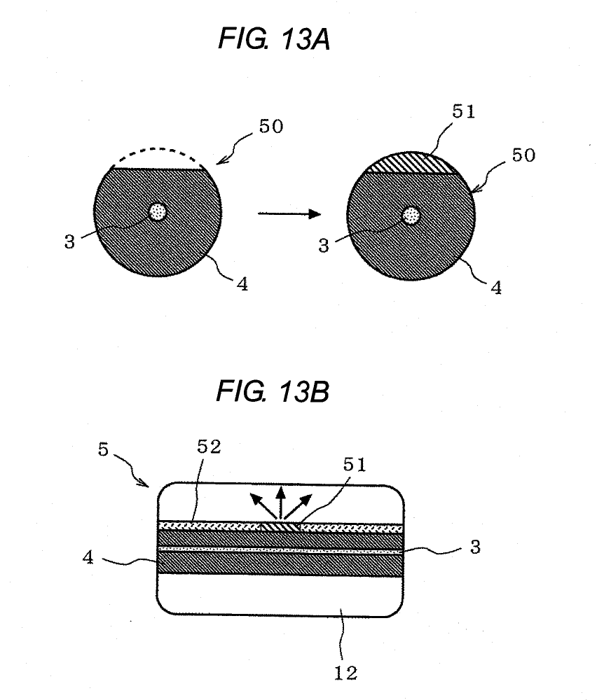

As illustrated in FIG. 13A, an optical fiber 50, which is the optical fiber 13 but a flat part is formed on part of the circumference thereof longitudinally along the core, is embedded in the ferrule 12 so that the flat part will face the light detector. In this arrangement, a high refractive index portion (that is, an optical refraction part) 51 having a refractive index not smaller than that of the core of the optical fiber 50 (core 3) may be provided on part of the surface of the flat part of the optical fiber 50 to form a light pick-up portion.

In this configuration, a low refractive index portion 52 having a refractive index not higher than that of the cladding of the optical fiber 50 (cladding 4) is provided on such surface of the flat part of the optical fiber 50 that the high refractive index portion 51 is not provided as illustrated in FIG. 13B so that light cannot leak from such a part other than the high refractive index portion 51. It should be reminded that the refractive index of the core of the optical fiber 13 is higher than that of the cladding.

In this light pick-up means comprised of the optical fiber 50 and the high refractive index portion 51 provided on part of the flat part of the optical fiber 50, light (the light incident on the ferrule 12 and scattered thereby) is picked up at the high refractive index portion 51 to which part of the communication signal light propagating in the core 3 of the joining element 5 is made coupled, similarly to the case in which the light pick-up means is comprised of the high refractive index component 46 and the V-groove 48. This configuration does not give any work on the portion (core 3) that conveys communication; therefore, the configuration does not affect on the transmission properties.

The flat part on the optical fiber 50 can be formed, for example, by drawing an optical fiber in such a manner that part of the surface of the cladding becomes flat longitudinally, or by cutting part of an optical fiber longitudinally after drawing.

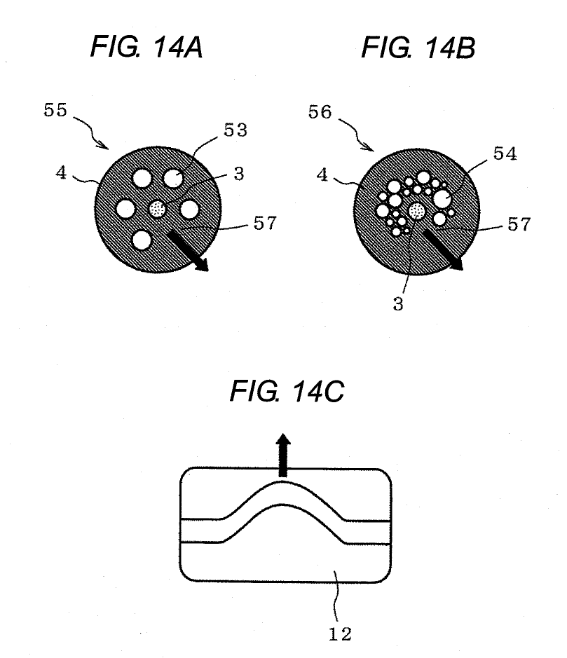

An optical connector by the fifth embodiment is characterized in that the connector uses an optical fiber 55 (or an optical fiber 56) having a light pick-up portion comprised of an array of a plurality of cavities (voids 53 or bubbles 54) arranged around the core 3 of the joining element 5 in an approximately-U-shaped configuration, as illustrated in FIGS. 14A and 14B.

As the ferrule 12 for embedding the optical fiber 55 (or the optical fiber 56), such a ferrule that the middle part of its hollow for accommodating the optical fiber 55 (or the optical fiber 56) having a convex bend (or concave bend) is used as illustrated in FIG. 14C for example. In arranging the optical fiber 55 (or the optical fiber 56) in the ferrule 12, an opening part 57 of the approximately-U-shaped configuration of the array, which is the light pick-up portion, is placed so that the opening part 57 convexes toward the detection hole 27.

Optical fibers 55 and 56 having the cavities (voids 53 or bubbles 54) therein (that is, a holey fiber) have a low bending loss. However, forming the opening part 57 makes the optical fiber 55 (or the optical fiber 56) bent, which enables light to leak therefrom. Therefore, directive light can be picked up in optional directions (upper side in FIG. 14C) enabling detection sensitivity to be enhanced.

In the case that the communication signal light is not in the wavelength range of invisible light but in the wavelength range of visible light, those optical connectors defined in embodiments stated above are still applicable. In such applications, the light outputted on the light output port 26 can be visually examined without using the light detector 2.

1. An optical connector for connecting optical transmission lines each other, said optical connector being comprised of at least
a connector main body and
a joining element provided inside said connector main body being interposed between said optical transmission lines and coupled to each end face of said optical transmission lines, wherein
said joining element is comprised of
a core and a cladding provided on the periphery of said core that are optically coupled to said optical transmission lines, and
a light pick-up means for picking up part of communication signal light being on-propagation along said optical transmission lines, and wherein
said connector main body has, in a position that faces said light pick-up means, an optical output port for outputting part of said communication signal light picked up by said light pick-up means to a light detector.

2. The optical connector according to claim 1, wherein said light pick-up means is comprised of a light detection groove formed, in a position that faces said optical output port, so that at least said core will be penetrated thereby.

3. The optical connector according to claim 2, wherein the inside of said light detection groove is filled with a resin having a refractive index smaller than that of said core.

4. The optical connector according to claim 2, wherein a scattering material that scatters part of said communication signal light to said optical output port is arranged inside said light detection groove.

5. The optical connector according to claim 2, wherein an optical branching filter that makes part of said communication signal light branched to said optical output port is arranged inside said light detection groove.

6. The optical connector according to claim 1, wherein said light pick-up means is comprised of an undulation portion formed on the surface of said core.

7. The optical connector according to claim 1, wherein said light pick-up means is comprised of a distorted portion formed on part of said core so that such part will have a mode field diameter different from the other part of said core.

8. The optical connector according to claim 1, wherein said light pick-up means has such a positional arrangement that the optical axis of said core on the end face of connection with a core of said optical transmission line is positioned being shifted from the optical axis of said core of said optical transmission line within an extent that the contact between said core and said core of said optical transmission line is maintained.

9. The optical connector according to claim 1, wherein said light pick-up means has such a geometric arrangement that the diameter of said core on the end face of connection with a core of said optical transmission line is different from the diameter of said core of said optical transmission line.

10. The optical connector according to claim 1, wherein said light pick-up means is comprised of a high refractive index component provided longitudinally in said cladding and having refractive index not smaller than that of said core, and
a V-groove formed applying a V-cutting from the surface of said joining element, which surface faces to said light output port, to part of said high refractive index component in such a manner that said V-groove will slant with respect to the optical axis of said high refractive index component.

11. The optical connector according to claim 1, wherein said light pick-up means is comprised of a flat part formed on said cladding longitudinally along said core so that part of the circumference of said cladding will be flat and
an optical refraction part, having a refractive index not smaller than that of said core, provided on part of the surface of said flat part.

12. The optical connector according to claim 1, wherein said light pick-up means is comprised of an open part in an approximately-U-shaped arrangement of a plurality of cavities arrayed surrounding said core.

13. The optical connector according to claim 12, wherein said open part is curved at the portion thereof that faces said optical output port toward said optical output port.

14. The optical connector according to claim 1, wherein a cover for closing said optical output port is provided on said connector main body in an openable-and-closable manner.

15. The optical connector according to claim 1, wherein said light detector is attached on said connector main body in a detachable manner.
